(19) United States
(12) Patent Application Publication
(10) Pub. No.: US 2008/0081149 A1
(43) Pub. Date: Apr. 3, 2008

(54) Gas diffusing laminated steel sandwich panels

(75) Inventors: Carlton D. Fuerst, Royal Oak, MI (US); Xiaohong Q. Gayden, West Bloomfield, MI (US); David R. Sigler, Shelby Township, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/536,037

(22) Filed: Sep. 28, 2006

(51) Int. Cl. B32B 3/10; B32B 3/00

(52) U.S. Cl. 428/137; 428/457; 428/166

(57) ABSTRACT

Laminated steel panels which are subjected to forming and assembly operations such as welding that subject the composite construction to high temperatures in localized regions. The metal laminate structure has metal skins sandwiching one or more layers of polymeric material. The polymeric material incorporates cavity structures which are designed to accommodate the gaseous components liberated during welding and other high temperature processes.

### TECHNICAL FIELD

The present invention relates generally to the field of metal laminate structures having metal skins sandwiching one or more layers of polymeric material. More particularly, the invention relates to laminated steel panels which are subjected to forming and assembly operations such as welding that subject the composite construction to high temperatures in localized regions.

### BACKGROUND OF THE INVENTION

Metal laminate structures are well known. Such structures typically have outer metal sheets of steel or other structural metal with one or more layers of polymer and/or metal disposed between the outer metal sheets. Such structures provide strength benefits due to the outer metal layers while having the benefit of reduced weight and sound absorption due to the polymeric interior.

Several different types of metal laminate structures are known. One such known structure is made up of metal sheets of similar or dissimilar composition with a low density polymeric core between the metal sheets. In such constructions the core thickness is normally about 40% to about 60% of the total laminate thickness. Another construction utilizes metal sheets of similar or dissimilar composition with a thin visco-elastic polymeric adhesive layer between the metal sheets. In such constructions, the core thickness is normally less than about 20% of the total laminate thickness. It is also known to use outer metal sheets of similar or dissimilar composition with one or more interior metal sheets with thin polymeric epoxy adhesive layers interposed between opposing metal sheets. In such constructions, the polymeric layers normally make up less than about 20% of the total laminate thickness.

Laminated steels have been used in the manufacture of automotive vehicles in various structural panel members. Specifically, laminated steel panels have been spot welded into vehicles during assembly. However, the use of laminated steel panels has been limited due to heat degradation of the polymer component at the high temperatures utilized in the welding process. This partial and localized breakdown of the polymer component releases byproducts including gaseous components. These gaseous components occupy much greater volume under standard room temperature conditions than the original polymer precursor. Accommodating the gaseous byproducts within the original internal structure of the laminated steel panels is problematic. It results in undesirable features and inconsistency in the product which can interfere with assembly operations and end use. These features include bulges, weld perforations, and delaminations, which can compromise part geometry, weld quality, and corrosion resistance.

### SUMMARY OF THE INVENTION

This invention is believed to provide advantages and alternatives over prior practices by providing a laminated steel panel including gas acceptance structures within the sandwich panel interior to store and/or expel the gases released at high temperatures thereby ensuring consistent part geometry, consistent welds, and reduced delaminations.

### BRIEF DESCRIPTION OF THE DRAWINGS

The accompanying drawings which are incorporated in and which constitute a portion of this specification illustrate an exemplary embodiment of the invention which, together with the general description above and the detailed description set forth below will serve to explain the principles of the invention wherein;

FIGS. 1 and 1A illustrate exemplary prior art metal-polymer laminate structures;

FIG. 2 illustrates a laminate structure as illustrated in FIG. 1 joined in welded relation to a support member;

FIG. 3 illustrates an exemplary metal-polymer laminate structure incorporating gas acceptance cavity structures within the polymeric layer;

FIG. 4 is an elevation view taken generally along line 4-4 in FIG. 3 showing the polymeric layer incorporating gas acceptance cavity structures;

FIGS. 4A and 4B are elevation views showing the polymeric layer incorporating different cavity configurations;

FIG. 5 illustrates a laminate structure as illustrated in FIG. 3 joined in welded relation to a support member; and

FIG. 6 illustrates a laminate to laminate spot weld connection using a pair of laminate structures as illustrated in FIG. 3;

While embodiments of the invention have been illustrated and generally described above and will hereinafter be described in connection with certain potentially preferred procedures and practices, it is to be understood and appreciated that in no event is the invention to be limited to such embodiments and procedures as may be illustrated and described herein. On the contrary, it is intended that the present invention shall extend to all alternatives and modifications as may embrace the broad principles of the invention within the true spirit and scope thereof.

### DETAILED DESCRIPTION

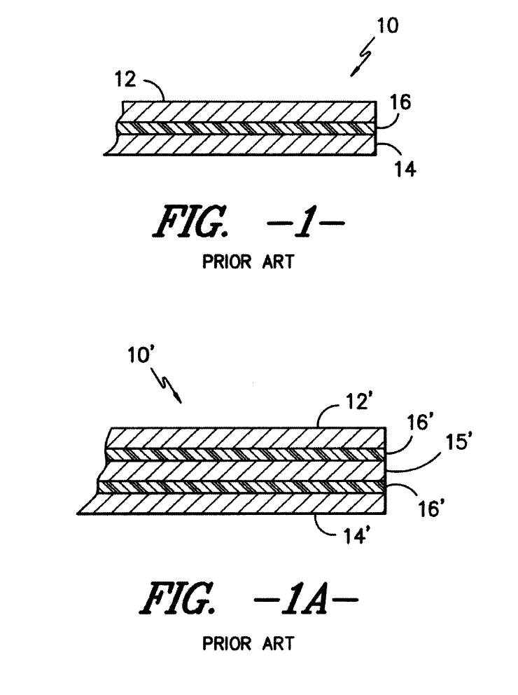

Reference will now be made to the various drawings wherein to the extent possible, like elements are designated by corresponding reference numerals in the various views. In FIG. 1, a laminate construction 10 is illustrated. The laminate construction 10 has a first surface layer 12 and a second opposing surface layer 14 with an intermediate polymeric layer 16 disposed between the two surface layers. The surface layers 12, 14 are preferably formed from a structural steel alloy or the like. Zinc coated steel may be particularly preferred. It is also contemplated that other ferrous or non-ferrous metals may be used including aluminum, high alloy stainless steels and the like. The surface layers 12, 14 may be either similar or dissimilar in composition.

The polymeric layer 16 may be formed of any polymeric resinous material suitable for lamination to the surface layers 12, 14 and with strength and glass transition temperature characteristics suitable to function under normal operating conditions. By way of example only, and not limitation, exemplary polymers may include ethylene polymers and co-polymers and propylene polymers and co-polymers. Such materials include polypropylene, low density or high density polyethylene, ethylene/vinyl acetate co-polymer, ethylene/acrylic copolymer, and ethylene/butene-1 and other alkene-1 co-polymers. Visco-elastic resins and aramid epoxy resins may be particularly preferred. The polymeric resin material can be bonded directly to the surface layers 12, 14 or can be held in place by an intermediate adhesive layer. The thickness of the polymeric layer 16 is preferably in the range of about 0.025 to about 0.040 mm although greater or lesser thickness may be used if desired.

In an alternative construction 10′ illustrated in FIG. 1A, one or more intermediate structural layers 15′ of metal or other materials is disposed at an intermediate position between the surface layers 12′, 14′ with polymeric layers 16′ of similar or dissimilar composition interposed between the opposing structural layers. Of course, any number of intermediate structural layers may be used as desired.

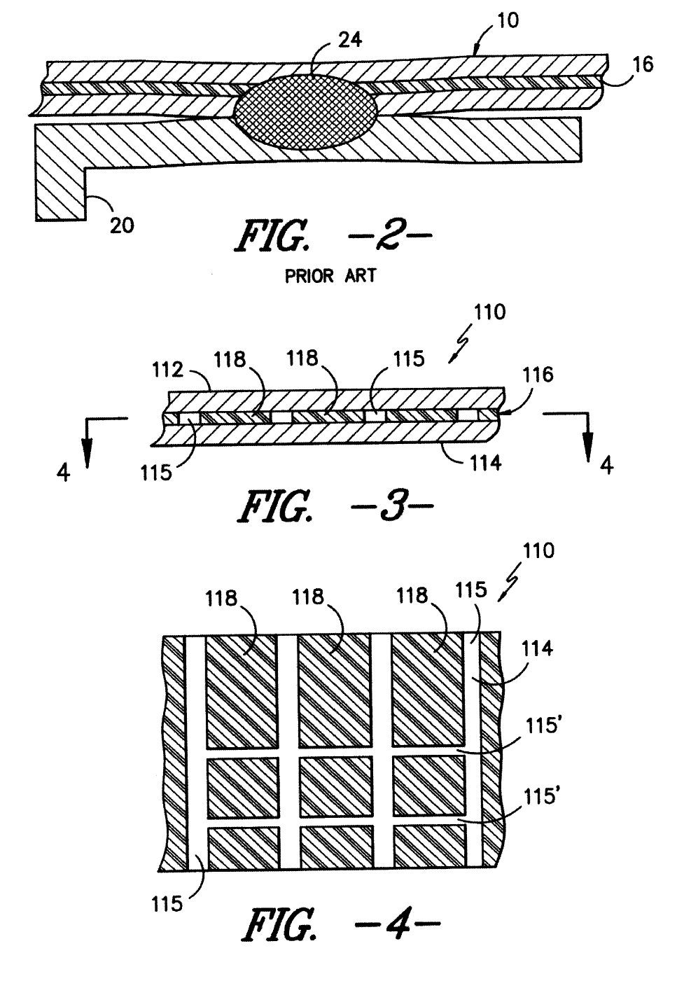

FIG. 2 illustrates the joining of laminate construction 10 as shown in FIG. 1 to a support member 20 using one or more spot welds 24. Of course, it is to be understood that constructions with intermediate structural layers such as illustrated in FIG. 1A may likewise be welded to a support member. Laminate constructions of similar or dissimilar configuration may also be welded to one another. As shown, the spot welds 24 extend substantially across the laminate construction 10 so as to effect a secure connection to the support member 20.

As will be appreciated, the welding process will typically result in melting of a portion of the polymeric layers in the vicinity of the spot welds 24. The welding process thus results in the release of combustion byproducts from the polymeric layers including gaseous components. These gaseous components occupy much greater volume under standard room temperature conditions than the original polymer precursor. Consequently, accommodating the gaseous byproducts within the original internal structure of the laminated panel is problematic. Pressure resulting from gaseous byproducts can compromise both weld integrity by forming blowholes at weld locations and sheet integrity by forcing open the metal surface layers forming bulges or delaminations. Delaminations are particularly harmful as they allow moisture to enter the laminate initiating crevice corrosion, which compromises panel durability.

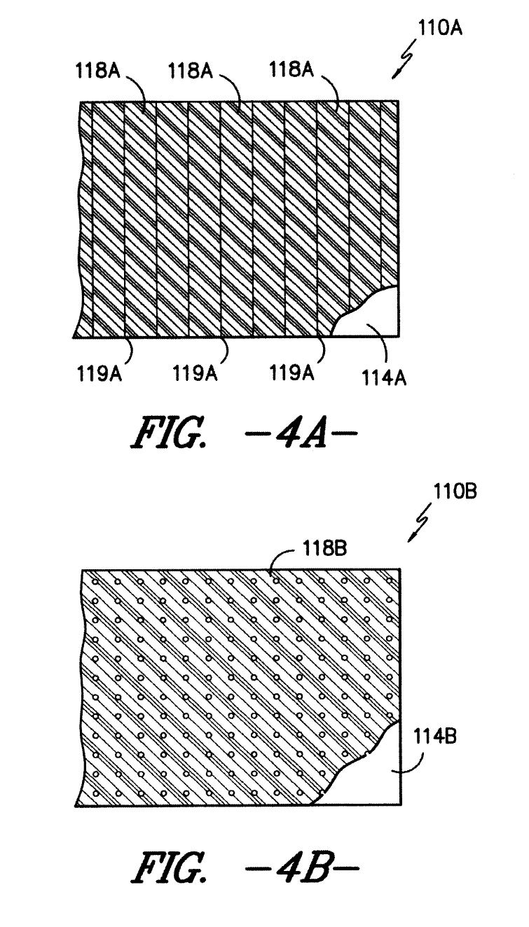

The invention disclosed herein derives from the observation that the released gases will equilibrate at lower pressures when cavity structures or reservoirs are incorporated in the enclosed volume between the surface layers 12, 14 of the laminate construction. FIG. 3 illustrates an exemplary laminate construction 110 incorporating cavity structures 115 within the polymeric layer 116. In the illustrated exemplary embodiment, the laminate construction 110 has a first surface layer 112 and a second opposing surface layer 114 with an intermediate polymeric layer 116 disposed between the two surface layers. The polymeric layer 116 is discontinuous so as to define covered zones of polymeric material 118 with voids defining gas acceptance cavity structures 115 in the form of channels between the covered zones. As best illustrated in FIG. 4, cavity structures 115 oriented in a first direction may be interconnected to one another by other cavity structures 115′ oriented in another direction so as to facilitate the dissipation of combustion gases across a broader surface area.

Of course, the configuration illustrated in FIG. 4 is exemplary only. In this regard, it is contemplated that the size, shape and orientation of the covered zones and cavity structures may be adjusted as desired. By way of example only, FIG. 4A shows an alternative laminate construction 110A with gas acceptance cavities which are in the form of slits or channels 119A between strips of polymeric material 118A. In the event that the polymeric material is elastic in character, it is contemplated that the slits or channels 119A may open up and expand when subjected to internal gas pressure thereby providing an arrangement of expanded reservoirs for generated gas products. Moreover, slits leading to the edge of the surface layer 114A allow gases to slowly escape from the interior over time.

FIG. 4B illustrates yet another exemplary construction 110B. In this construction, the cavities within the polymeric material 118B are relatively short length slits or pinholes. In the event that the polymeric material 118B is elastic in character, it is contemplated that such short length slits or pinholes may open up and expand when subjected to internal gas pressure thereby providing an arrangement of expanded reservoirs for generated gas products. Moreover, while the pinholes are illustrated as being substantially discrete from one another, it is likewise contemplated that at least a portion of the pinholes may be interconnected. To the extent that the pinholes are interconnected to some degree to define an open cell or semi-open cell structure, it is contemplated that stored gases may escape from the interior to the edge of the surface layer 114B over time.

As will be appreciated from the exemplary constructions as set forth above, the cavities in the polymeric layer may have non-zero initial volume or they may have essentially zero initial volume. The cavities may be discrete or interconnected and they can even provide open paths for gas to easily flow to the atmosphere. The cavities may be created in the polymer layer mechanically (e.g. punching holes, slicing channels), chemically (e.g. chemical etch or spray), or thermally (laser or heated probe) removing a small amount of polymer material from the layer in a pattern distributed across the entire surface or concentrated in a pattern at strategic locations. Cavities may also be formed by initially limiting the area covered by polymeric material, such as by applying polymer in a predetermined pattern leaving desired areas of the surface layers uncovered with the polymeric material. The cavities may be created by slicing short or long channels or slits in connecting or non-connecting patterns across the entire surface or concentrated in a pattern at strategic locations. The cavities also may be intentionally introduced during curing and rolling operations used to produce the sandwich structure of the metal-polymer laminate structures. The polymeric material may be formulated or processed so that the layer or layers may form dimples or holes within the layer or on the surface of the polymer layer during curing or rolling pressures. The cavities may be one sided, that is cavities may not appear on both surfaces of the polymer layer. If more than one polymer sheet is applied with the laminate structures, the cavities may be created in one or more of the layers. The cavities may be incorporated in the polymer materials before being applied to the metal panel, or after. Any combination of the aforementioned cavities is permissible as well as any and all combinations of cavities which fall within the spirit and scope of the invention.

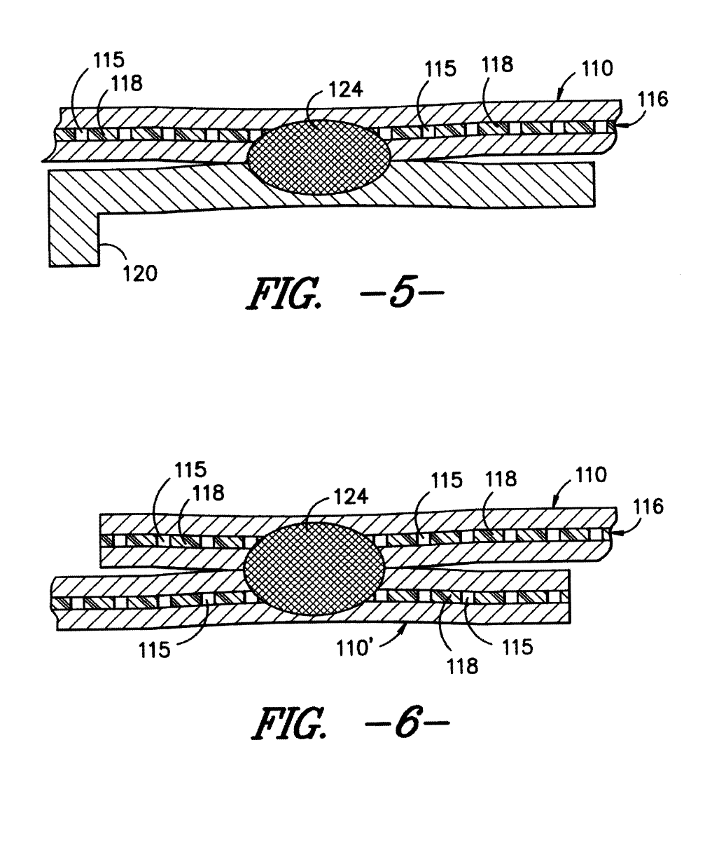

Regardless of the structure of the formed cavities, the result is the development of gas accepting reservoirs that can accept gases produced during welding or other assembly processes. By way of example only, the resulting characteristic of gas collection is illustrated in FIG. 5 which corresponds generally to FIG. 2 as previously described. As shown, in this arrangement laminate construction 110 as shown in FIG. 3 is welded to a support member using one or more spot welds 124. Of course, it is to be understood that constructions with multiple intermediate polymer layers may likewise be utilized. Of course, it is to be understood that constructions with different types of cavities such as illustrated in FIGS. 4A and 4B may likewise be utilized. Combinations of the various constructions may also be joined if desired.

As previously noted, the high temperature of the welding process results in the liberation of gaseous by-products as material within the polymer layer is melted. As shown in FIG. 5, the polymer layer 116 is discontinuous defined by zones covered by polymeric material in combination with cavity structures 115 that accommodate gaseous combustion products. As combustion gases are generated they collect in the cavity structures and diffuse away from the spot welds so as to establish pressure equilibrium across a substantial region within the polymer layer 116.

Although the welding arrangement illustrated in FIG. 5 is in the form of a laminate structure welded to a non-laminate support, it is likewise contemplated that any number of other welding arrangements may be accommodated. By way of example only, it is contemplated that two laminate constructions of similar or dissimilar make-up may be welded together. One such arrangement is illustrated in FIG. 6, wherein a laminate construction 110 is disposed in overlapping relation to a second laminate construction 110′ with spot welds 124 joining the layers together. As shown, the cavity structures 115 in the laminate constructions 110, 110′ accommodate the gas released during the welding process.

It is to be understood that while the present invention has been illustrated and described in relation to potentially preferred embodiments, constructions, and procedures, that such embodiments, constructions, and procedures are illustrative only and that the invention is in no event limited thereto. Rather, it is contemplated that modifications and variations embodying the principals of the invention will no doubt occur to those of skill in the art. It is therefore contemplated and intended that the present invention shall extend to all such modifications and variations as may incorporate the broad aspects of the invention within the true spirit and scope thereof.

1. A metal-laminate structure comprising a first metal surface layer, a second opposing metal surface layer, and at least one intermediate polymeric layer disposed between said first and said second metal surface layers wherein said at least one intermediate polymeric layer comprises a predefined arrangement of cavity structures adapted to receive gas produced by the polymeric layer during heat degradation.

2. The invention according to claim 1 wherein said cavity structures are selected from the group consisting of grooves, channels, slits, pinholes, dimples, and holes.

3. The invention according to claim 1 wherein said intermediate polymeric layer comprises a visco-elastic polymer.

4. The invention according to claim 1 wherein said cavity structures are discrete.

5. The invention according to claim 1 wherein said cavity structures are interconnected.

6. The invention according to claim 1 wherein at least a portion of said cavity structures are connected to the outside atmosphere.

7. The invention according to claim 1 wherein said cavity structures are disposed across a single side of said polymeric layer.

8. The invention according to claim 1 wherein said cavity structures are disposed across both sides of said polymeric layer.

9. The invention according to claim 1 wherein said first and second metal layers comprise zinc coated steel.

10. A metal-laminate structure comprising a first metal surface layer, a second opposing metal surface layer, and at least one intermediate polymeric layer of visco-elastic polymer disposed between said first and said second metal surface layers wherein said at least one intermediate polymeric layer comprises a predefined arrangement of expansible cavity structures adapted to expand and receive pressurized gas produced by the polymeric layer during heat degradation, wherein at least a portion of the cavity structures are substantially closed at atmospheric pressure.

11. The invention according to claim 10, wherein said cavity structures comprise expansible slits.

12. The invention according to claim 10, wherein said cavity structures comprise expansible pin holes.

13. The invention according to claim 10, wherein said cavity structures are discrete.

14. The invention according to claim 10, wherein said cavity structures are interconnected.

15. The invention according to claim 10, wherein at least a portion of said cavity structures are connected to the outside atmosphere.

16. The invention according to claim 10, wherein said cavity structures are disposed across a single side of said polymeric layer.

17. The invention according to claim 10, wherein said cavity structures are disposed across both sides of said polymeric layer.

18. The invention according to claim 10, wherein said first and second metal layers comprise zinc coated steel.

19. A method of forming a metal-laminate structure comprising the steps of:
providing a first metal surface layer and a second opposing metal surface layer; and
arranging at least one intermediate polymeric layer between said first and said second metal surface layers wherein said at least one intermediate polymeric layer comprises a predefined arrangement of cavity structures adapted to receive gas produced by the polymeric layer during heat degradation.
